(19) United States
(12) Patent Application Publication
(10) Pub. No.: US 2004/0042629 A1
(43) Pub. Date: Mar. 4, 2004

(54) Automatic earpiece sensing

(76) Inventors: Charles M. Mellone, Boynton Beach, FL (US); Shafer Burch Seymour, Bartlett, IL (US)

Correspondence Address: Barbara R. Doutre, Motorola, Inc., Law Department, 8000 West Sunrise Boulevard, Fort Lauderdale, FL, 33322, US

(21) Appl. No.: 10/232,144

(22) Filed: Aug. 30, 2002

(51) Int. Cl. H04R 1/10; H04R 5/02

(52) U.S. Cl. 381/310; 381/74

(57) ABSTRACT

An earpiece device (300) provides automatic left/right ear sensing for stereo reception as well as the ability to receive two separate and distinct channel signals. The earpiece device (300) provides an orientation indication as to which ear or channel it is coupled. A pair of such devices can be used as stereo headphones providing interchangeability between ears. The devices can also be used to receive distinct and separate channel signals. Thus, a communication system can automatically adjust a transmission to the headphone device in response to the orientation of the earpieces with minimal effort on the part of the user.

### FIELD OF THE INVENTION

This invention relates generally to audio listening devices and more specifically to audio earpieces for stereo.

### BACKGROUND OF THE INVENTION

Headphones and headsets come in a variety of form factors and can be wired or wireless. Headphones are typically listen-only devices having two earpieces that couple to a user's ears. Headsets are generally thought of as both listening and transmitting devices because they typically include a microphone along with one or two earpieces. Both headphones and headsets require two earpieces for stereo reception. Stereo headsets and headphones allow for the reception of simultaneous audio channels. For each earpiece to play back the proper channel, however, each earpiece must be placed in the appropriate ear. When used in a stereo environment, if the two earpieces have the same form factor then left and right ear designators must be marked so as to provide optimized stereo reception to the user. Thus, the user is burdened with having to position each earpiece on the correct ear by reading left and right labels on the headphone or headset.

FIG. 1 shows a set of prior art headphones 100 consisting of a pair of wrap around wired earpieces 102, 104. In this case, each earpiece fits only one ear using two separate form factors. This burdens the manufacturer with having to design separate form factors (one form factor for each ear) and to make sure that each shipment includes the two different form factors. A shipment error of two similar form factors would prevent the user from being able to wear the product.

Accordingly, it would be desirable to have an improved earpiece device that could be used for stereo reception in headphones and headsets.

### BRIEF DESCRIPTION OF THE DRAWINGS

The present invention is illustrated by way of example and not limitation in the accompanying figures, in which like references indicate similar elements, and in which:

FIG. 1 is an example of a set of prior art headphones in accordance with the prior art;

FIG. 2 is an integrated microphone/receiver system in accordance with the prior art;

FIG. 3 is a partially exploded view of an earpiece formed in accordance with the preferred embodiment of the invention;

FIGS. 4 and 5 show a headphone device formed in accordance with the preferred embodiment coupled to a user's ears;

FIG. 6 is a set of headphones indicating first and second orientations in accordance with the present invention; and

FIG. 7 is the set headphones of FIG. 6 with the earpieces interchanged in accordance with the present invention.

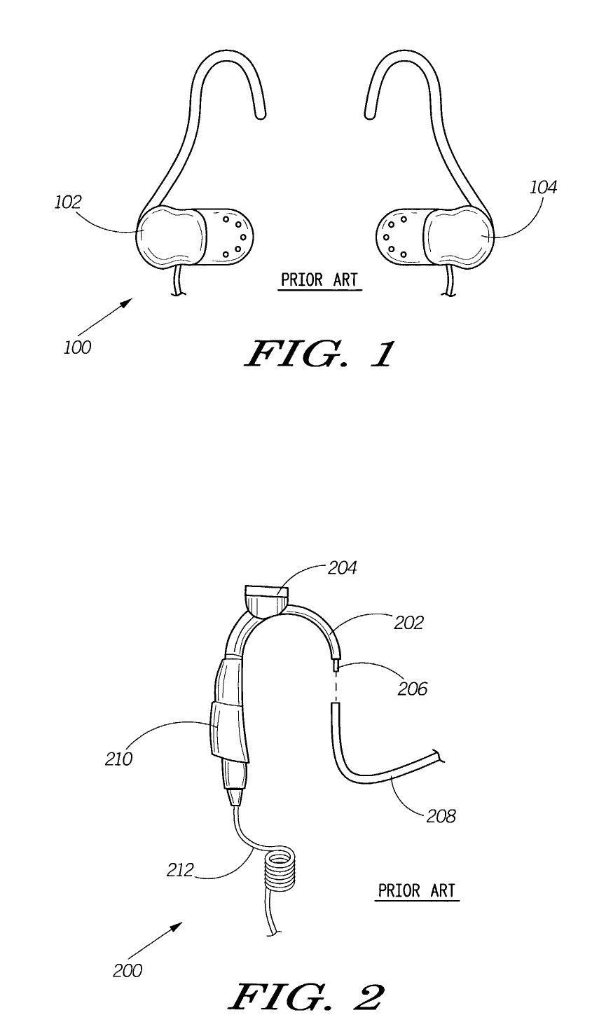

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE DRAWINGS

The apparatus to be described herein provides an earpiece device with automatic left/right location sensing capability, enabling two such devices to provide stereo reception with minimal user adjustment. In accordance with the present invention, interchangeable earpieces provide different angles of rotation when coupled to different ears and are thus capable of being used in either ear. An existing earpiece, known in the art, will initially be described and then an example given of how this earpiece can be modified and adapted into a stereo headphone system. While the preferred embodiment describes a preferred earpiece form factor, those skilled in the art will recognize that the concept can be extended to a variety of earpiece form factors.

Integrated microphone/receiver systems exist in a variety of form factors many of which can be worn about the ear as a single earpiece. Referring to FIG. 2, there is shown a prior art integrated microphone/receiver system manufactured by Motorola, Inc. System 200 is a hooked shaped earpiece device having a form factor to fit around the typical human ear. A main portion 210 houses device electronics (not shown) that receive and process audio signals along with a microphone 204. A tubular portion 202 extends from the main portion 210 and curves in a hook like manner for fitting around the top and front portions of the ear. The tubular portion 202 has a terminal end 206 that functions as a receptacle or tube mount for an attached sound delivery tube 208. The sound delivery tube 208 is pivotable about the terminal end 206 to accommodate left and right ear use, and angular corrections to match a user's ear canal access. The rotation angle of the sound delivery tube 208 is thus different for the left or right ear.

Devices like those shown in FIG. 2 enable the wearer to hear and be heard clearly and are often used by firefighters, police, and factory workers to facilitate hearing under adverse conditions, such as transportation and construction environments. These devices are typically coupled through a conductive cable 212 to the user's radio, such as a two-way radio. In accordance with the preferred embodiment of the invention to be described next, the form factor of the earpiece device described above is modified and provided as two earpieces adapted for use as stereo headphones.

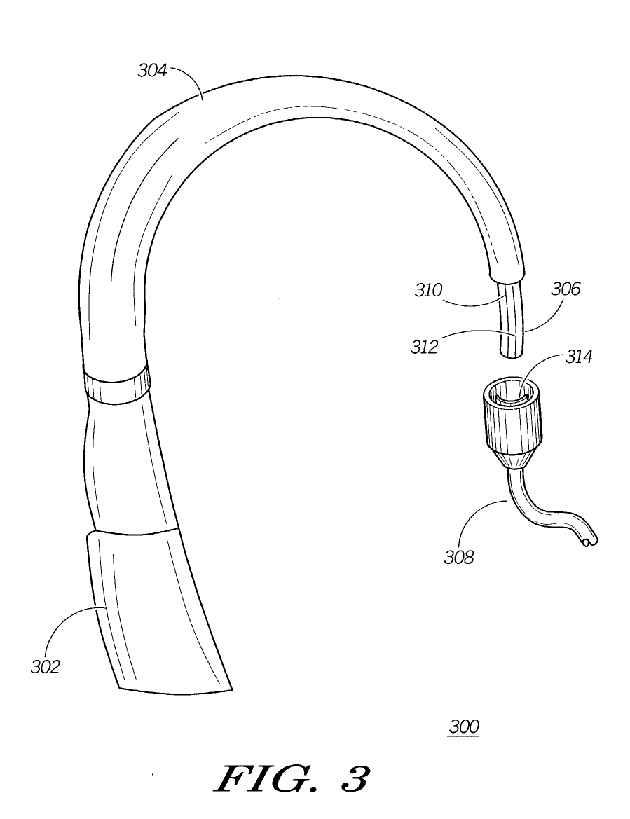

FIG. 3 shows a partially exploded view of an earpiece device in accordance with the preferred embodiment of the invention. Like assembly 200, assembly 300 includes a main portion 302 for housing electronics (not shown) for processing audio signals. Assembly 300 further includes a tubular portion 304 having a terminal end 306 that functions as a receptacle or tube mount for an attached sound delivery tube 308. In accordance with the preferred embodiment of the invention, the terminal end 306 includes first and second conductive wires 310, 312, and the sound delivery tube 308 includes a conductive liner 314. The conductive liner 314 is situated such that, when assembled, the conductive wires 310, 312 are either shorted together or open circuited depending on the rotation of the sound delivery tube 308. In accordance with the preferred embodiment, open or short-circuiting of the conductive wires 310, 312 is used as an indicator as to the left or right orientation of the earpiece device. A variety of other approaches, some of which will be described later, can be used to provide the orientation information as well.

Alternative form factors other than that shown in FIG. 3 can also be used. For example, the sound delivery tube 308 could be eliminated and replaced with a pivotable ear bud form factor. The different angles of rotation provided by the pivotable aspect of the device allows for automatic left/right ear sensing. An earpiece can thus receive left or right audio channels, making two such devices interchangeable. Depending on which ear each earpiece is coupled, a communication device can respond and always provide left and right audio channels simultaneously to the left and right ears. A microphone could also be added to one or more earpieces if desired for headset transmit capability.

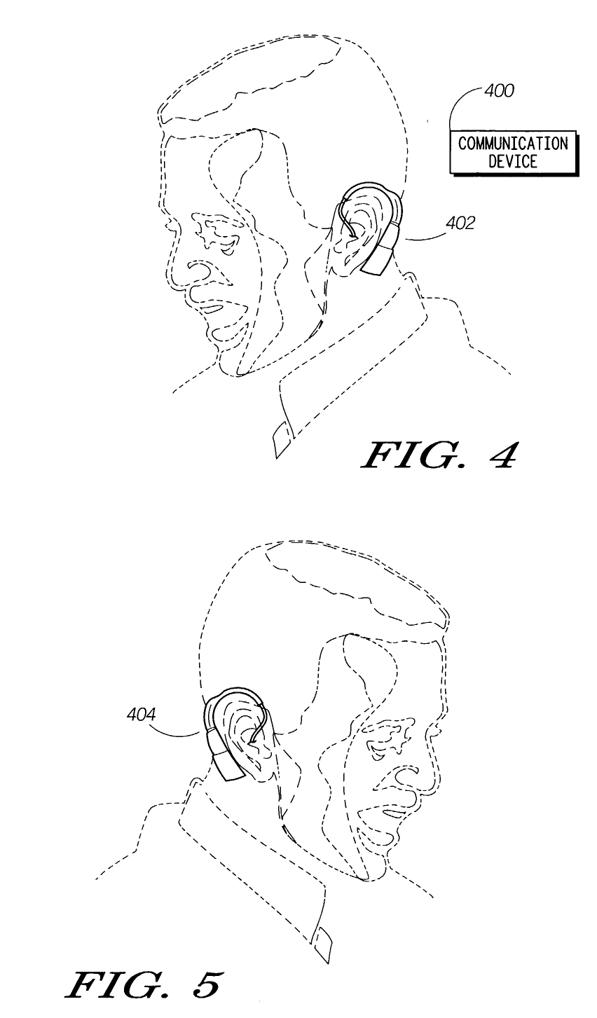

Referring now to FIGS. 4 and 5, two earpieces formed in accordance with the preferred embodiment of the invention provide stereo headphones for a user (shown in phantom). Earpiece 402 is coupled to the user's left ear while earpiece 404 is coupled to the user's right ear. In accordance with the present invention, each earpiece 402, 404 provides orientation information such that a communication device 400, such as a radio or other audio source device, automatically senses to which ear each of the first and second earpieces is coupled. The different angles of orientation provide indicators, such as a short on one side and an open on the other side, for automatic left/right sensing.

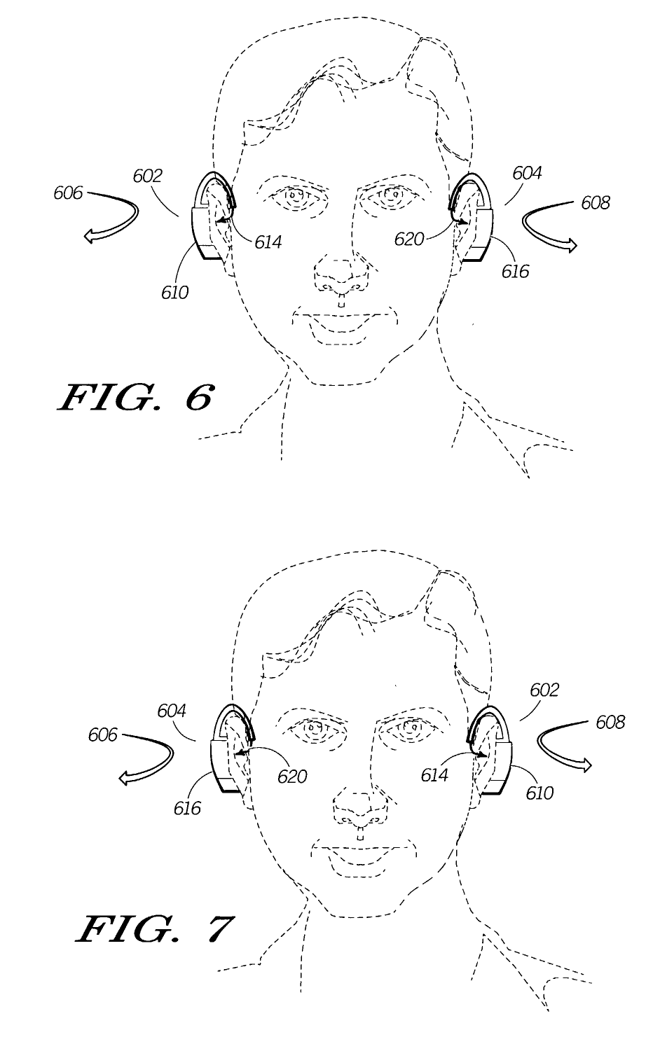

Referring now to FIGS. 6 and 7 there is shown a headphone device 600 formed in accordance with the preferred embodiment and worn in a face forward view. Headphone device 600 includes earpieces formed in accordance with the preferred embodiment. The headphone device 600 includes a first earpiece 602 for coupling to a user's ear, and a second earpiece 604 for coupling to the user's other ear. In accordance with the present invention, each earpiece 602, 604 provides orientation information such that a communication device, such as a radio, automatically senses to which ear each of the first and second earpieces is coupled. First earpiece 602 and second earpiece 604 provide first and second orientations 606, 608 when coupled to the user's ears.

The first earpiece 602 includes electronics for processing audio signals housed in main portion 610, and a terminal end (not shown, but previously described) leads into sound delivery tube 614. The second earpiece 604 likewise includes electronics for processing audio signals housed in a main portion 616, and a terminal end (not shown, but previously described) leading to a sound delivery tube 620. In accordance with the preferred embodiment, each earpiece 602, 604 includes two conductors on each terminal end (not shown, but previously described). Also in accordance with the preferred embodiment, each sound delivery tube 614, 620 includes a conductive liner (not shown, but previously described) coating a portion of the tube's inner surface. The sound delivery tube 614 is inserted into either ear with a first angle of rotation 606 as shown in FIG. 6. The second delivery tube 620 is inserted into the other ear with a second angle of rotation 608 different from the first as indicated in FIG. 6. In this example, it will be assumed that the first angle of rotation 606 provides an open circuit between the conductors while the second angle of rotation 608 shorts the conductors together. As mentioned above, the conductors being shorted together indicates either a left or right ear orientation. The conductors being open-circuited indicates the opposite ear orientation. The open/short indication is received by the earpiece electronics and used as an indicator for a communication device to orient a stereo signal properly to each ear.

FIG. 7 shows the headphone device 600 with the earpieces 602, 604 interchanged in accordance with the present invention. Again, system 600 includes first and second earpiece 602 and 604, however the earpieces have now been inserted into opposite ears. The orientation of each sound delivery tube 614, 620 is rotated to accommodate insertion into the opposite ear. The second earpiece 604 now has the first orientation 606 while the first earpiece 602 has the second orientation 608. In this orientation the two conductors on the terminal end of tube 620 are open-circuited for orientation 606 while the conductors on the terminal end of sound delivery tube 614 are short-circuited to provide orientation 608.

As mentioned above, the conductors being shorted together indicates either a left or right ear orientation. The conductors being open-circuited indicates the opposite ear orientation. Accordingly, if the first earpiece orientation generates a short-circuit indicator at the right ear, then the second earpiece orientation will indicate an open-circuit on the left ear. When the earpieces are swapped, the first earpiece orientation will indicate an open-circuit on the left ear, and the second earpiece will indicate a short circuit on the right ear. The ability to sense left and right orientation allows the audio source to provide a stereo signal to the appropriate ears. The headphone device 600 can be used to receive audio signals from a variety of communication sources including but not limited to radios, cellular phones, CD players, and televisions to name a few.

While the preferred embodiment has been discussed in terms of a “short circuit” approach to providing orientation information, a variety of other techniques can be used as well. For example, a micro-switch and mechanical pit implementation can also be used. In this type of implementation, as the eartube is rotated, the micro-switch falls in the pit and opens/closes the contact. A mechanical approach can also be used to achieve similar results by using two transducers emanating the audio along with the rotation of the eartubes to direct the appropriate transducer to each ear. Thus, a variety of approaches can be taken to provide the orientation information.

While the headphones of the present invention have thus been described in terms of left/right stereo audio pair transmissions, the two audio channels need not be limited to this specific application. Since the two audio channels are separate and distinct, the signals provided to these channels can also be distinct and unrelated signals. Using the notation of Channel A and Channel B, instead of left/right, Channel A can use a first orientation and Channel B can use a second orientation as previously described. The following provides examples of distinct channels:

For use with a television: Channel A=Primary program audio, Channel B=SAP (secondary audio program, an alternate language track for instance).

For use with a television: Channel A=Main picture audio, Channel B=PIP (picture in picture) channel audio.

For use as a museum audio tour guide: Channel A=main narration, Channel B=alternate language, or perhaps a more detailed, or more technical, program for the advanced listener.

For use with a DVD player: Channel A=Main audio, Channel B=commentary track.

Orientation information has been described thus far as originating from the earpiece, and the communication device making a routing decision based on that information. In another alternative embodiment, the communication device (such as communication device 400 in FIG. 4) can broadcast both channels to both left and right devices. The earpiece devices themselves select which channel goes to which earpiece, for example through the use of internal control circuitry. This alternative embodiment makes many applications, like the “audio tour guide” discussed above quite simple to implement.

Those skilled in the art will recognize that the above examples represent only a few of the possible channel combinations that might be useful to users. Since the two distinct channels each have a distinct orientation associated with them, there is no need to label the devices and the devices are interchangeable.

With the advancements in wireless technology, such as Bluetooth technology, many wireless systems are beginning to emerge in the marketplace. Wireless earpieces and headsets provide users with extra mobility. Bluetooth technology can provide three audio channels simultaneously thus allowing for stereo capability in a wireless environment as well as independent channels. Headphones formed in accordance with the present invention can take advantage of this capability without the problems of orientation previously discussed.

Accordingly there has been provided a headphone device comprising first and second earpieces having automatic left/right ear sensing for stereo as well as the ability to receive two separate and distinct audio channels. The headphones can be wired or wirelessly coupled to a communication device. The interchangeability of the earpieces of the present invention eases the burden on the manufacturer because a single form factor can be used for both pieces. Minimal effort is required by the user because the need to read orientation labels is eliminated. Each earpiece provides appropriate orientation in either ear, thus providing an improved earpiece device.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential features or elements of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

We claim:

1. A headphone device comprising first and second earpieces, each earpiece providing automatic orientation information.

2. The headphone device of claim 1, wherein the automatic orientation information provides left/right ear sensing.

3. The headphone device of claim 1, wherein the automatic orientation information provides left/right ear sensing for stereo.

4. The headphone device of claim 1, wherein the automatic orientation information provides first and second distinct channels.

5. A headphone device for a communication system, comprising:
a first earpiece for coupling to a user's ear;
a second earpiece for coupling to the user's other ear;
the first and second earpieces providing orientation information to the communication system indicating to which ear each is coupled; and
the communication system automatically adjusting a stereo signal to the headphone device in response to the orientation of the first and second earpieces.

6. The headphone device of claim 5, wherein the communication system includes a radio.

7. The headphone device of claim 5, wherein the communication system includes a cellular phone.

8. The headphone device of claim 5, wherein the communication system includes a television.

9. The headphone device of claim 5, wherein the communication device includes a DVD player.

10. A headphone device for a radio, comprising:
a first earpiece for coupling to a user's ear;
a second earpiece for coupling to the user's other ear; and
the radio automatically sensing to which ear the first and second earpieces are coupled.

11. The headphone device for a radio as described in claim 10, wherein the radio adjusts a stereo emission to the headphone device depending on which of the ears each of the first and second earpieces is coupled.

12. A stereo headphone device for a radio, comprising:
a first earpiece coupled to the radio;
a second earpiece coupled to the radio;
the first and second earpieces being interchangeable between a user's left and right ears; and
the radio automatically sensing to which of the user's ears the first and second earpieces are coupled, and the radio adjusting a stereo signal to the stereo headphone device in response thereto.

13. The stereo headphone device of claim 12, wherein the first earpiece provides a short circuit when coupled to the right ear and the second earpiece provides an open circuit when coupled to the left ear.

14. The stereo headphone device of claim 13, wherein the second earpiece provides a short circuit when coupled to the right ear and the first earpiece provides an open circuit when coupled to the left ear.

15. The stereo headphone of claim 12, wherein the first earpiece provides an open circuit when coupled to the right ear, and the second earpiece provides a short circuit when coupled to the right ear.

16. The stereo headphone of claim 15, wherein the second earpiece provides an open circuit when coupled to the right ear, and the first earpiece provides a short circuit when coupled to the right ear.

17. A stereo headphone device for receiving an audio signal from a communication device, comprising:
a first earpiece for receiving left or right audio channels;
a second earpiece for receiving left or right audio channels;
the first and second earpieces being interchangeable and providing left/right orientation information to the communication device; and
the communication device providing left and right audio channels simultaneously to the first and second earpieces depending on which ear each earpiece is coupled.

18. The stereo headphone device of claim 17, wherein each earpiece is wired to the communication device.

19. The stereo headphones device of claim 17, wherein each earpiece is coupled wirelessly to the communication device.

20. The stereo headphone device of claim 17, wherein the communication device communicates with the headphone device using a Bluetooth protocol.

21. A headphone device for a multi-channel communication system, comprising:
a first earpiece for coupling to a user's ear;
a second earpiece for coupling to the user's other ear;
the first and second earpieces providing orientation information to the communication system indicating to which ear or to which channel each earpiece is coupled; and
the multi-channel communication system automatically adjusting a signal to the headphone device in response to the orientation of the first and second earpieces.

22. A headphone device for a communication system as described in claim 21, wherein the first and second earpieces receive left/right stereo transmissions from the communication system.

23. A headphone device for a communication system as described in claim 21, wherein the first and second earpieces receive first and second distinct audio channels from the communication system.

24. A headphone device for a communication system as described in claim 23, wherein the communication system is a television and the first channel is a primary program audio channel and the second channel is a secondary audio program channel.

25. A headphone device for a communication system as described in claim 23, wherein the communication device is a television and the first channel is a main picture audio channel while the second channel is a picture in picture (PIP) audio channel.

26. A headphone device for a communication system as described in claim 23, wherein the communication system is a DVD player and the first channel provides main audio while the second channel provides a commentary track.

27. The headphone device of claim 21, wherein each earpiece is wired to the communication device.

28. The headphone device of claim 21, wherein the each earpiece is wirelessly coupled to the communication device.

29. The headphone device of claim 21, wherein the each earpiece includes a pivotable portion for indicating coupling to the left or right ear.

30. A headphone device for a communication system, comprising:
first and second earpieces providing automatic orientation information; and
the communication device broadcasting multi-channels to both the first and second earpiece devices, the first and second earpieces devices selecting which of the multi-channels goes to which earpiece.
